(19) United States
(12) Patent Application Publication
(10) Pub. No.: US 2021/0398017 A1
(43) Pub. Date: Dec. 23, 2021

(54) SYSTEMS AND METHODS FOR CALCULATING VALIDATION LOSS FOR MODELS IN DECENTRALIZED MACHINE LEARNING

(71) Applicant: Hewlett Packard Enterprise Development LP, Houston, TX (US)

(72) Inventors: Vishesh GARG, Bangalore (IN); Sathyanarayanan MANAMOHAN, Bangalore (IN); Saikat MUKHERJEE, Bangalore (IN); Krishnaprasad Lingadahalli SHASTRY, Bangalore (IN)

(21) Appl. No.: 17/205,632

(22) Filed: Mar. 18, 2021

(30) Foreign Application Priority Data
Jun. 23, 2020 (IN) 202041026528

(51) Int. Cl. G06N 20/00; G06K 9/62

(52) U.S. Cl. CPC G06N 20/00; G06K 9/6289; G06K 9/6262; G06K 9/6261

(57) ABSTRACT

Systems and methods are provided for calculating validation loss in a distributed machine learning network, where nodes train local instances of a machine learning model using local data maintained at those nodes. After each training iteration of the local instances of the machine learning model, each node may calculate a local validation loss value corresponding to the performance of the local instance of the machine learning model trained at each of the nodes. Those local validation loss values may be shared with an elected leader that can average all the local validation loss values, return a global validation loss value to the nodes. The nodes may then determine whether or not training of their local instance of the machine learning model should stop or continue.

### CROSS REFERENCE TO RELATED APPLICATIONS

This application is related to co-pending and co-owned U.S. patent application Ser. No. 16/163,484, entitled “SYSTEM AND METHOD OF DECENTRALIZED MANAGEMENT OF MULTI-OWNER NODES USING BLOCKCHAIN,” to co-pending and co-owned U.S. application Ser. No. 16/773,555, entitled “SECURE PARAMETER MERGING USING HOMOMORPHIC ENCRYPTION FOR SWARM LEARNING,” and to co-pending and co-owned U.S. application Ser. No. 16/773,397, entitled “SYSTEMS AND METHODS FOR MONETIZING DATA IN DECENTRALIZED MODEL BUILDING FOR MACHINE LEARNING USING A BLOCKCHAIN,” each of which is incorporated herein by reference in their entirety.

### DESCRIPTION OF THE RELATED ART

Geo-distributed, decentralized enterprise infrastructures or systems such as factory floors, clusters of geographically distributed servers, fleets of autonomous vehicles, Internet of Things (IoT) networks, and the like can be difficult to manage. Aside from being decentralized, these systems can be massive in scale, and heterogeneous in nature. It can be appreciated that managing such systems may present logistic challenges that are compounded when these infrastructures have or interact with devices (also referred to as “nodes”) that operate outside of an enterprise network, e.g., are owned by another one or more users or entities.

Machine learning (ML) can refer to a method of data analysis in which the building of an analytical model is automated. ML is commonly considered to be a branch of artificial intelligence (AI), where systems are configured and allowed to learn from gathered data. Such systems can identify patterns and/or make decisions with little to no human intervention.

Blockchain can refer to a tamper-proof, decentralized ledger that establishes a level of trust for the exchange of value without the use of intermediaries. A blockchain can be used to record and provide proof of any transaction on the blockchain, and is updated every time a transaction occurs.

### BRIEF DESCRIPTION OF THE DRAWINGS

The technology disclosed herein, in accordance with one or more embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof.

FIG. 1A illustrates an example of a system of decentralized management of device assets outside a computer network in accordance with an embodiment of the disclosed technology.

FIG. 1B illustrates an example of a management node in a distributed blockchain network for decentralized management of device assets outside a computer network in accordance with an embodiment of the disclosed technology.

FIG. 1C illustrates an example of an edge node in a distributed blockchain network for decentralized management of device assets outside a computer network in accordance with an embodiment of the disclosed technology.

FIG. 1D illustrates an example of a blockchain interface layer for decentralized management of device assets outside a computer network in accordance with an embodiment of the disclosed technology.

FIG. 2A illustrates an example swarm learning architecture in accordance with an embodiment of the disclosed technology.

FIG. 2B illustrates example stages and operational flow of swarm learning in accordance with an embodiment of the disclosed technology.

FIG. 3 illustrates an example of homomorphic encryption.

FIG. 4A illustrates example operations performed in a distributed blockchain network for electing a merge leader in accordance with an embodiment of the disclosed technology.

FIG. 4B illustrates example operations performed in a distributed blockchain network for requesting and publishing a public key in accordance with one embodiment of the disclosed technology.

FIG. 4C illustrates example operations performed in a distributed blockchain network for decentralized parameter encryption and homomorphic merging of the decentralized parameters in accordance with one embodiment of the disclosed technology.

FIG. 4D illustrates example operations performed in a distributed blockchain network for electing a decryptor that is not the merge leader in accordance with one embodiment of the disclosed technology.

FIG. 4E illustrates example operations performed in a distributed blockchain network for distribution of the merged decentralized parameters in accordance with one embodiment of the disclosed technology.

FIG. 4F illustrates completion of the decentralized parameter merging in accordance with one embodiment of the disclosed technology.

FIGS. 5A-5B illustrate example operations performed in a distributed network for machine learning model validation in accordance with one embodiment.

FIG. 6 is an example computing component that may be used to implement various functions of a training node in accordance with one embodiment of the disclosed technology.

FIG. 7 is an example computing component that may be used to implement various functions of a leader node in accordance with one embodiment of the disclosed technology.

FIG. 8 is an example computing component that may be used to implement various features of embodiments of the present disclosure.

The figures are not intended to be exhaustive or to limit embodiments to the precise form disclosed. It should be understood that the invention can be practiced with modification and alteration, and that the disclosed technology be limited only by the claims and the equivalents thereof.

### DETAILED DESCRIPTION

Distributed or decentralized ML can refer to ML model building across multiple nodes using data locally available to each of the nodes. The local model parameters learned from each local model can be merged to derive a global model, where the resulting global model can be redistributed to all the nodes for another iteration, i.e., localized data trains the global model. This can be repeated until the desired level of accuracy with the global model is achieved.

Model training in general, involves separating available data into training datasets and validation datasets, where after running a training iteration using the training dataset, a model can be evaluated on its performance accuracy by performing on data it has never seen, i.e., the validation dataset. The degree of error or loss resulting from this evaluation is referred to as validation loss. Validation loss can be an important aspect of ML for implementing training features. For example, validation loss can be used to avoid overfitting a model on training data by creating an early stopping criterion in which training is halted once the validation loss reaches a minimum value. As another example, validation loss can be used in an adaptive synchronization setting, where the length of a synchronization interval is modulated based on the progress of validation loss values across multiple iteration (i.e., modulating the synchronization frequency).

However, in a distributed ML environment, where data is not maintained in a central/single location, validation is not possible at any single participating node during training. Therefore, according to some embodiments, prior to each training iteration, at each local/participating node, respective local datasets are divided into training validation datasets, and a local training iteration commences in batches using local training datasets. At the end of each training batch, a node designated as a merge leader for that batch merges the parameters from each of the participating nodes (including itself) to build a global model, at which point, the merged parameters can be shared with the rest of the participating nodes. The merged parameters are then applied to each local model at each of the participating nodes, and the updated local models are then evaluated using the previously identified validation dataset, and each participating node shares their respective/local validation loss value with the leader. The merge leader merges/averages the local validation loss values to arrive at a global validation loss value, which can then be shared with the rest of the nodes. In this way, a global validation loss value can be derived based on the universe of participating nodes, and that global validation loss value can be used by each of the participating nodes to determine if training can stop or if further training may be needed.

In particular, upon determining that a quorum of nodes in a swarm learning network are ready to merge their respective model parameters, (1) a merge leader is elected. It should be understood that in swarm learning, each node possessing local training data trains a common ML model without sharing the local training data to any other node or entity in the swarm blockchain network. This is accomplished by sharing parameters (weights) derived from training the common ML model using the local training data. In this way, the learned insights regarding raw data (instead of the raw data itself) can be shared amongst participants or collaborating peers nodes, which aids in protecting data against privacy breaches. Moreover, swarm learning as described herein leverages blockchain technology to allow for decentralized control, monetization, and ensuring trust and security amongst individual nodes.

The merge leader may (2) request a separate key manager to generate a public key that can be used to encrypt the local model parameters of the nodes. Upon obtaining the public key, the merge leader (3) publishes it to a distributed ledger of the swarm blockchain network that includes the nodes. Each node may read (but may not write to the distributed ledger), and thus may (4) obtain the public key and proceed with encrypting the local model parameters. It should be noted that the public key may be a compute-intensive encryption process that is relegated to the edge (the nodes), avoiding any scaling bottlenecks.

The nodes may (5) signal/inform the merge leader that they are respectively ready to merge their local model parameters. The merge leader (6) downloads the local model parameters and performs a merge operation (homomorphic summation and scalar multiplication). Because merging of the local model parameters is performed by an elected merge leader rather than a static, centralized server, a distributed/decentralized implementation can be achieved. This in turn, can provide greater fault-tolerance than conventional implementations. Nodes have the collective intelligence of the overall network without the raw data ever needing to leave its corresponding node. The merge leader may (7) inform the nodes that the merged parameters/updated global model is ready for decryption. All the nodes, other than that elected to be the merge leader (8) elect a decryptor to decrypt the merged parameters making up the updated global model.

While the remaining nodes wait, the decryptor (9) requests a private key from the key manager, downloads the merged parameters from the merge leader, decrypts the merged parameters, uploads the merged parameters to the merge leader, and instructs the key manager to discard the public-private key pair. The decryptor (10) signals that the merged parameters are available from the merge leader. The nodes (11) download the now, decrypted merged parameters, and apply them to their local model for an ML model building iteration. More localized parameters may be computed/generated, and additional ML model building iterations (training) can occur.

At this point, after a training iteration, the aforementioned method of calculating validation loss may be performed to derive a global validation loss value that can be used to assess each local model at each participating node. Thus, a cycle of training and validation can be effectuated even in a distributed ML system. It should be noted that in some embodiments, the already-elected merge leader may act as the leader for validation, i.e., averaging/merging local validation loss values to arrive at a global validation loss value. However, in other embodiments, another leader for validation averaging/merging may be selected, albeit use of the same leader for parameter/weight merging as well as validation loss value averaging can be faster (due to no having to select another leader node).

In some embodiments, validation loss values can be masked using homomorphic encryption techniques to preserve privacy in a manner similar to that already described for encrypting/decrypting the local model parameters of the nodes. Again, the merge leader may request a separate key manager to generate a public key that can be used to encrypt the local model parameters of the nodes. It should be noted that the same key manager used prior (for generating the asymmetric key pair for parameter (weight) homomorphic encryption) can be used to generate a new asymmetric key pair for use in encrypting local validation loss values. However, in other embodiments, a different key manager can also be used to generate the new asymmetric key pair. Upon obtaining the public key, the merge leader publishes it to the edge network to a distributed ledger of the swarm blockchain network that includes the nodes. Each node may obtain the public key and proceed with encrypting its local validation loss value. It should be noted that the public key may be a compute-intensive encryption process that is relegated to the edge (the nodes), avoiding any scaling bottlenecks.

The nodes may signal/inform the merge leader that they are respectively ready to merge their local validation loss values. The merge leader downloads the local validation loss values and performs a merge operation (homomorphic summation and scalar multiplication). Because merging of the local validation loss values is performed by an elected merge leader rather than a static, centralized server, a distributed/decentralized implementation can be achieved. This in turn, can provide greater fault-tolerance than conventional implementations. The merge leader may inform the nodes that the merged local validation loss value is ready for decryption. All the nodes, other than that elected to be the merge leader elect a decryptor to decrypt the merged local validation loss value.

While the remaining nodes wait, the decryptor requests a private key from the key manager, downloads the merged local validation loss value from the merge leader, decrypts the merged local validation loss value, uploads the merged local validation loss value to the merge leader, and instructs the key manager to discard the public-private key pair. The decryptor signals that the merged local validation loss value is available from the merge leader. The nodes download the now, decrypted merged local validation loss value, and can assess the performance of their local ML model.

Embodiments of the technology disclosed herein build on distributed ML and blockchain. Distributed ML, as alluded to above, can be leveraged for its ability to train a common model across multiple nodes (global model) using data (or a subset(s) of data) each node of the network, as well as validate local models across multiple nodes. The blockchain aspect allows for decentralized control and scalability, while also providing the requisite fault-tolerance to enable embodiments to work beyond the single enterprise/entity context. Moreover, the blockchain aspect introduces a tamper-proof/resistant cryptocurrency, with which participating nodes or data sources can use to monetize their data contribution(s) to training the global model.

The blockchain framework will be described first. A controller framework can be provided that allows participant nodes in a network to interact with each other using blockchain technology. The use of blockchain technology for these interactions may be implemented to ensure that the interactions are secured, non-repudiated, sequenced and permissioned. Embodiments may also be implemented to use a blockchain to allow participants to evolve a consensus protocol for one or more aspects of the distributed ML portion of the swarm learning framework. For example, consensus protocols can be agreed by all participants (nodes) and implemented as smart contracts in the system using blockchain technology.

In another embodiment, operations may be implemented to provide provenance tracking across a heterogeneous distributed storage platform to track which nodes conducted which operations on which systems. In some applications, metadata operations may be routed via a blockchain and storage devices or other network entities can be configured to accept operations only via the blockchain interface. For example, storage devices on the network can be commanded to allow metadata operations only via the blockchain interface. In this way, factors such as identity, authorization, provenance, non-repudiation and security can be provided for operations on nodes managed in this way.

Accordingly, embodiments may be implemented in which the management operation becomes decentralized and the system no longer requires a central entity to enforce policies. Particularly, in some applications, the system may be implemented with no central management server, and may instead use only a management node or nodes to input management instructions onto the blockchain using blockchain transactions (such as the aforementioned merge leader, decryptor, etc. Once a change is approved, a device may implement the change and the blockchain can be used to provide a clear record of state of the system as it evolves over time. Because embodiments may be implemented in a peer-to-peer environment without a central management entity, the enterprise is scalable without limitations on how many nodes a central management entity might be able to address. Additionally, the absence of a central management entity may also eliminate his entity as a single point of failure. This may provide the added benefit of reducing attack surfaces by eliminating a single point of failure that might otherwise be used to bring the system down.

Decentralized management of assets operating outside a computer network (also referred to as edge nodes) from within the computer network may be achieved. The edge nodes may include enterprise devices and the computer network may include the enterprise's network, Network traffic to and from the computer network may pass through a firewall around the computer network. A management server (also referred to as a management node) may operate within the firewall to manage the configuration of edge nodes operating outside the firewall using blockchain technology. The management node and the edge nodes may be part of a blockchain network.

The management node may act as a full node that stores a complete or at least updated copy of a distributed ledger. The management node may also act as a that has permission to write blocks to the distributed ledger. The management node may mine management operations in the form of change requests into the distributed ledger. The management operations may include, without limitation, removal of an edge node from the network (such as resulting from non-compliance of the edge node to set protocols followed by the network). Management operations may also include the addition of a new asset (edge node) to the network and configuring of that new asset, as well as proposal of a new software update that will be installed on all edge nodes. Further still, management operations can include the execution of a status check on some or all of the edge nodes, and/or other operations that can be remotely ordered and applied locally at an edge node.

Updates to the distributed ledger are propagated to all of the nodes (such as the edge nodes and the management node) according to a blockchain specification, including via peer-to-peer sharing. This permits the management node to communicate change requests to edge nodes through the distributed ledger in a secure and immutable way. This also permits generation of a historic and current record of the management operations. As such, a historic and current state of the system may be stored and retrieved from the distributed ledger.

Each of the edge nodes may act as a full node that stores a complete or at least updated copy of the distributed ledger. In some instances, none of the edge nodes have permission to write to the distributed ledger and therefore cannot issue change requests to other edge nodes. An edge node may read its local copy of the distributed ledger to obtain the change requests. Upon receipt of a change request, the edge node may implement the change request and update its state to indicate the change request has been implemented. This state transition may be broadcast to other nodes, such as in the form of a blockchain transaction. The management node may collect transactions not yet written to the distributed ledger and write them to the distributed ledger, thereby ensuring an immutable and distributed record of change requests and state transitions. As such, the distributed ledger may record the current and historic configuration of the edge nodes.

Use of the foregoing architecture ensures management operations are secured, non-repudiated, sequenced, and permissioned. Management operations become partially “decentralized”; as a data center within a computer network serves as a management node that enforces policies and electronically proposes changes. Once a change is mined into the distributed ledger, each of the systems implement the change and there is a clear record and undisputable record of state of the system as it progressed and evolved over time. For example, an edge node can synchronize its copy of the distributed ledger from other edge nodes (or from the management node) to obtain the current, valid, and immutable configuration of the system. The foregoing permits system scaling, as any participant of the system may access current (and historic) state information from the distributed ledger. New edge nodes may be added by providing the new node with a copy of the distributed ledger, A new edge node may then configure itself according to the current state information from its copy of the distributed ledger or otherwise obtain software or other updates consistent with the current state information.

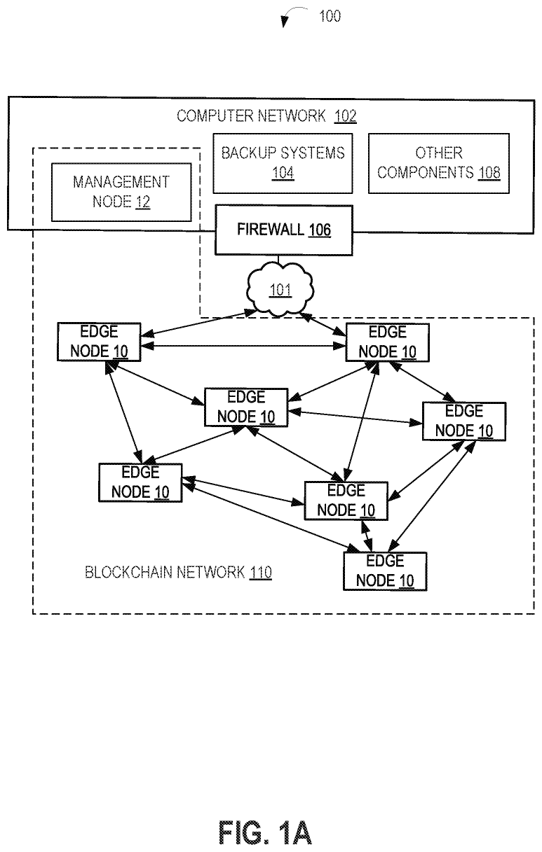

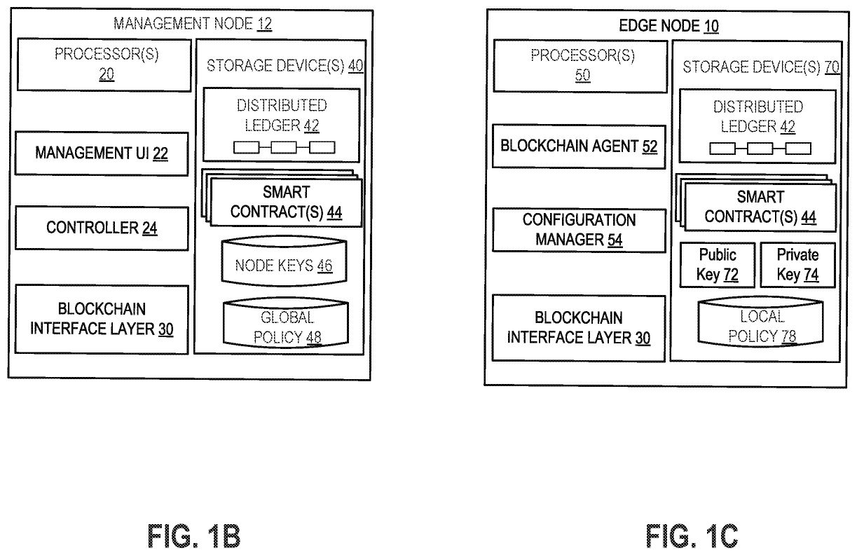

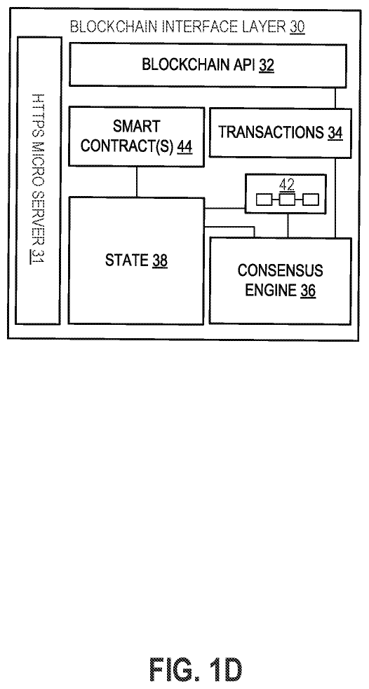

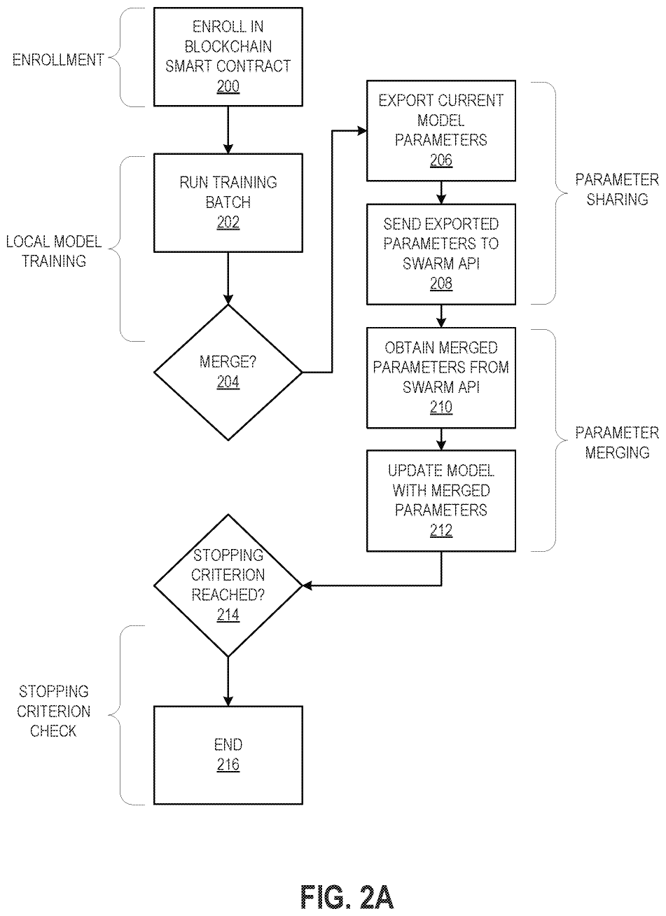

FIG. 1A illustrates an example of a system 100 of decentralized management of device assets outside a computer network 102, according to an implementation of the invention. System 100 may include a blockchain network 110. The blockchain network 110 may include a plurality of nodes that are connected to one another using one or more connection protocols, including a peer-to-peer connection protocol. The nodes of the blockchain network 110 may include a management node 12 and edge nodes 10. The particular number of, configuration of, and connections between the edge nodes 10 may vary. As such, the arrangement of the edge nodes 10 shown in FIG. 1A is for illustrative purposes only.

The management node 12 is part of and operates within a firewall 106 of computer network 102 and the edge nodes 10 operate outside the firewall. As alluded to above, and as will be described in greater detail below, such edge nodes 10 may contribute data that can be used to train a local instance of a global ML model in a swarm learning context. The computer network 102 may also include one or more backup systems 104 that provides failover protection for the management node 12 and/or other components 108 operating within the computer network. The components of the computer network 102 may communicate with one another via a local area network (“LAN”). The components of the computer network 102 may communicate with devices outside the computer network 102 through the firewall 106. The firewall 106 may be configured as a software firewall and/or a hardware firewall device. The firewall 106 may include or connect with a network switch device that routes network traffic into and out of the computer network via the firewall. The network 101 may include a wide area network (“WAN”) that connects devices outside the firewall 106.

Examples of further details of a management node 12 will now be described with reference to FIG. 1B. The management node 12 may include one or more processors 20 (also interchangeably referred to herein as processors 20, processor(s) 20, or processor 20 for convenience), one or more storage devices 40, and/or other components. The processor 20 may be programmed by one or more computer program instructions. For example, the processor 20 may be programmed to execute a management user interface 22 (illustrated as “management user interface 22”), a controller 24, a blockchain interface layer 30, and/or other instructions to perform various operations, each of which are described in greater detail herein. As used herein, for convenience, the various instructions will be described as performing an operation, when, in fact, the various instructions program the processors 20 (and therefore management node 12) to perform the operation.

The management user interface 22 may provide an interface, such as a graphical user interface, a command line interface, and/or other type of interface configured to receive management option inputs. For instance, a user such as a system administrator may use the management user interface 22 to input management operations to be conducted on one or more of the edge nodes 10 of the blockchain network 110, or to input an edge node to be added. In this manner, the user may manage edge nodes 10 based on change requests originating from within the computer network 102.

The controller 24 may obtain management operations to be performed and may communicate them to the relevant edge nodes 10. The management operations may be obtained from the management user interface 22 and/or a global policy 48. Controller 24 may communicate the management operations using the blockchain interface layer 30. For example, the controller 24 may write the management operations into a blockchain transaction that is broadcast to the edge nodes 10. The blockchain transaction may be broadcast using a multicast protocol to several or all edge nodes 10. In some instances, the blockchain transaction may be broadcast using peer-to-peer networking in which the management node 12 acts as a peer to broadcast the transaction to at least one other peer (in this case, an edge node 10), which broadcasts the transaction to other peers and so on. In some implementations, the controller 24 may wait until a blockchain transaction is signed by an edge node 10 as described herein before writing the transaction to a block (also referred to herein as a “ledger block”) of the distributed ledger 42. In these implementations, the edge nodes 10 may obtain management operations directly from the broadcasted transaction. In other implementations, the controller 24 may write the transaction to a block of the distributed ledger 42. In these implementations, the edge nodes 10 may obtain management operations by obtaining the current (in other words latest) block that references transactions having management operations.

In whichever manner the controller 24 broadcasts the management operations to edge nodes 10 using the blockchain interface layer 30, the controller may do so to in a manner that is directed all edge nodes 10. For example, a management operation of “check status” may be directed to all nodes of the blockchain network 110 so that each edge node is instructed to perform a status check. Each edge node 10 will then perform the status check and broadcast its state indicating the results of the status check (or other management operation as described below).

In some instances, the controller 24 may target one or more edge nodes 10 to receive a management operation. In these implementations, the controller 24 may generate a blockchain transaction and/or a block on the distributed ledger 42 directed to the targeted edge node(s) 10. For instance, the controller 24 may encode an identifier of the edge node 10 that is targeted. Alternatively or additionally, the controller 24 may encode a device type that targets certain types of edge nodes 10 that should perform management operations. Still other examples include locations that should be targeted such that edge nodes in certain geolocations are targeted. The smart contracts 44 may include rules, which each edge node 10 follows, that direct the nodes to inspect transactions and/or blocks to determine whether it should apply a management operation contained in the transaction and/or block. In some implementations, the controller 24 may encrypt the management operation to be performed with a target edge node's 10 public key such that only the target edge node can decrypt the management operation with its private key.

In some instances, certain management operations may be executed periodically without user intervention. For example, controller 24 may execute a daemon or other process that periodically causes a status check from all edges nodes 10 to be executed. This daemon may periodically generate relevant change requests, which are issued to the edge nodes 10—and tracked via—the distributed ledger 42.

In an implementation, the controller 24 may enforce global policy 48 by ensuring that the state of the network complies with the global policy. For instance, the controller 24 may periodically obtain the current system state from the distributed ledger 42. As noted elsewhere, state transitions of the edge nodes 10 may be recorded on the distributed ledger 42. Alternatively or additionally, the result of status checks may be written to the distributed ledger 42, indicating the current state of the system. The controller 24 may compare the current system state (such as state of the blockchain network 110) with the global policy 48, which may specify a desired state of the system. The desired state may include a macro state of the system as a whole and/or a micro-state of any individual or group of edge nodes. Any discrepancies may be noted and an edge node 10 in non-compliance may be targeted for executing a management operation that will resolve the non-compliance. In some instances, the smart contracts 44 and/or global policy 48 may encode rules that specify when a non-complying edge node 10 should be taken offline. For instance, the rules may specify an edge node 10 that continues to be in non-compliance after N number of blocks have been written to the distributed ledger 42 should be taken offline. Other parameters may specify such removal as well. The foregoing may ensure recurring policy enforcement and compliance using the blockchain interface layer 30.

In one embodiment, in connection with certain types of management operations, the controller 24 may make available files for download. For instance, operating system images, software updates, new software, and/or other downloadable files or data may be made available for edge nodes 10 to download in connection with a management operation. As will be described below, in some embodiments, downloadable files may include files containing particular encryption keys, merged parameters, etc. This may ensure that the distributed ledger 42 itself does not have to store such files or data but stores an immutable record of current files or data that should be used (as well as historic listing of such files or data).

The blockchain interface layer 30 may be used to interface with the distributed ledger 42 in accordance with the smart contracts 44. The blockchain interface layer 30 is described with reference to FIG. 1D below.

The storage devices 40 may store a distributed ledger 42, smart contracts 44, node keys 46, and/or other data. The distributed ledger 42 may include a series of blocks of data that reference at least another block, such as a previous block. In this manner, the blocks of data may be chained together. An example of a distributed ledger is described in the well-known white paper “Bitcoin: A Peer-to-Peer Electronic Cash System,” by Satoshi Nakamoto (bitcoin.org), the contents of which are incorporated by reference in its entirety herein. The distributed ledger 42 may store blocks that indicate a state of an edge node 10 relating to its configuration or other management information.

The smart contracts 44 may include rules that configure nodes to behave in certain ways in relation to decentralized management of edge nodes. For example, the rules may specify deterministic state transitions, which nodes may enroll to participate in decentralized management, rules for implementing a change request issued by the management node 12, and/or other actions that an edge node 10 or management node 12 may take for decentralized management. In some embodiments, such rules may specify when to elect a merge leader, what edge node 10 to exclude from decry, for election, etc.

The node keys 46 may store public encryption keys of edge nodes 10 in association with their identities (such as Internet Protocol or other addresses and/or identifying information). In this manner, in some implementations, change requests may be targeted to specific edge nodes 10 and encrypted using the target edge node's public key.

The global policy 48 may store a security or other policy for the system. The global policy 48 may include, for example, network configuration settings, security configuration settings, operating system settings, application settings, policy rules, and/or other policy information for devices managed by the management node 12.

Examples of further details of an edge node 10 will now be described with reference to FIG. 1C. An edge node 10 may be a fixed or mobile device. While only one of the edge nodes 10 is illustrated in detail in the figures, each of the edge nodes 10 may be configured in the manner illustrated. The edges nodes 10 may communicate with one another in a peer-to-peer manner. The edge nodes 10 may each include one or more processors 50 (also interchangeably referred to herein as processors 50, processor(s) 50, or processor 50 for convenience), one or more storage devices 70, and/or other components.

The processor 50 may be programmed by one or more computer program instructions. For example, the processor 50 may be programmed to execute a blockchain agent 52, a configuration manager 54, a blockchain interface layer 30, and/or other instructions to perform various operations, each of which are described in greater detail herein. As used herein, for convenience, the various instructions will be described as performing an operation, when, in fact, the various instructions program the processors 50 (and therefore edge node 10) to perform the operation.

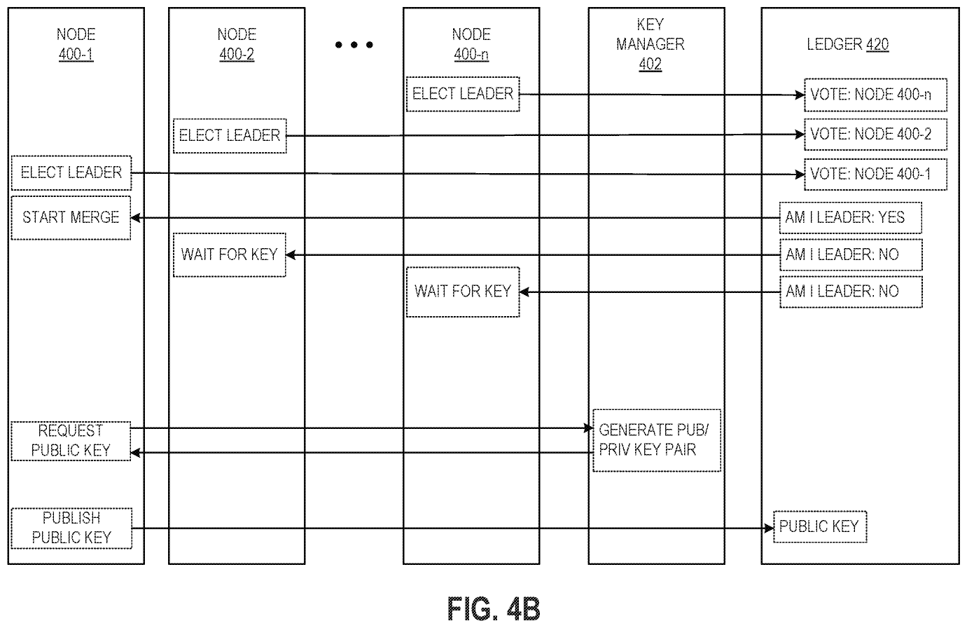

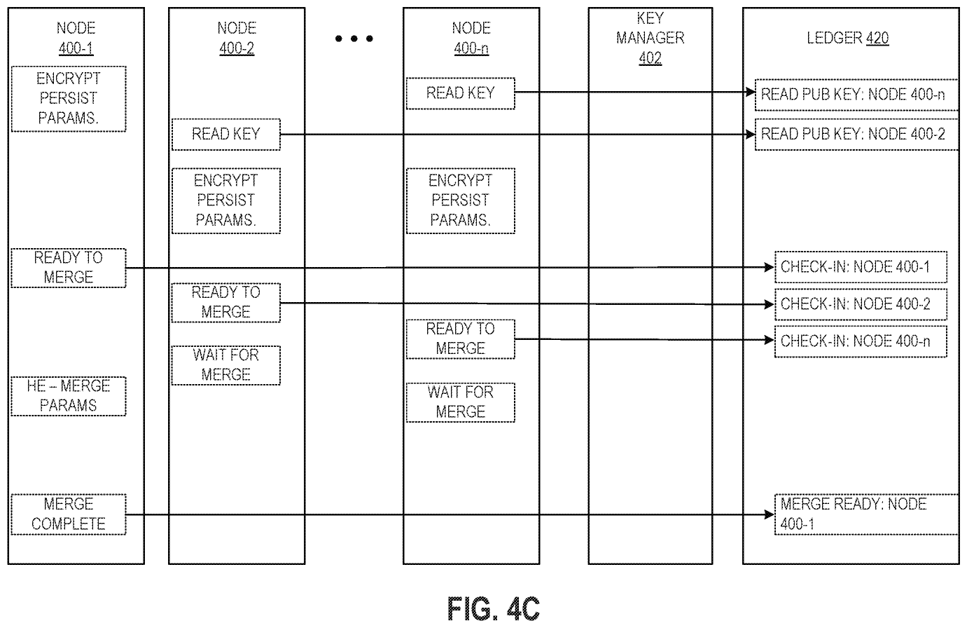

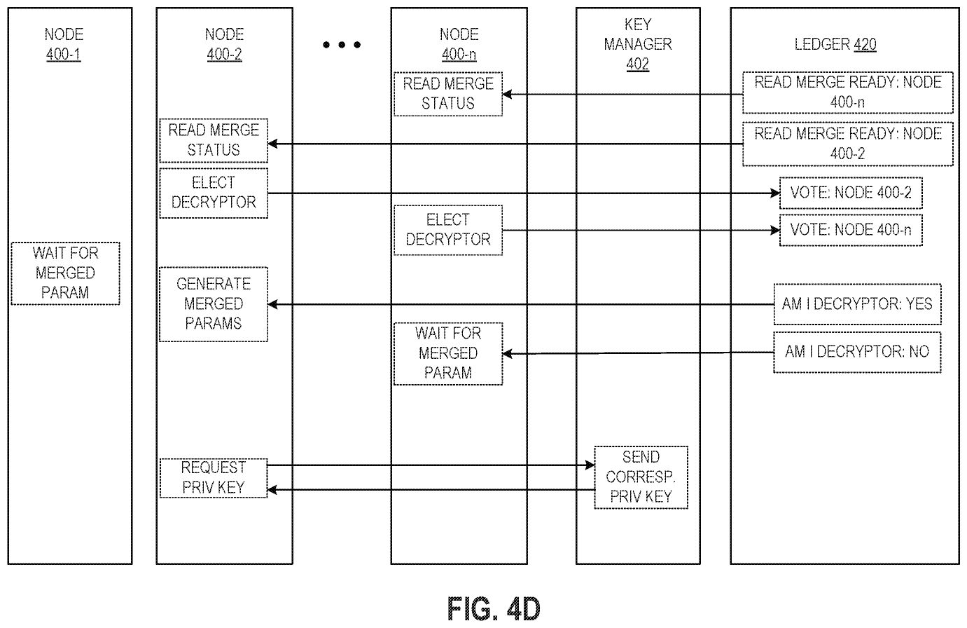

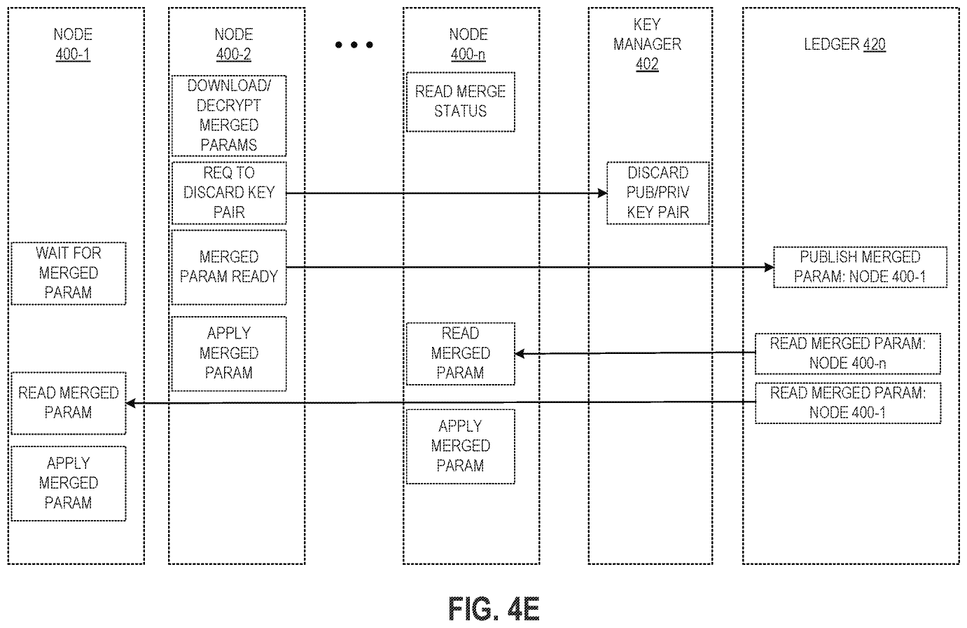

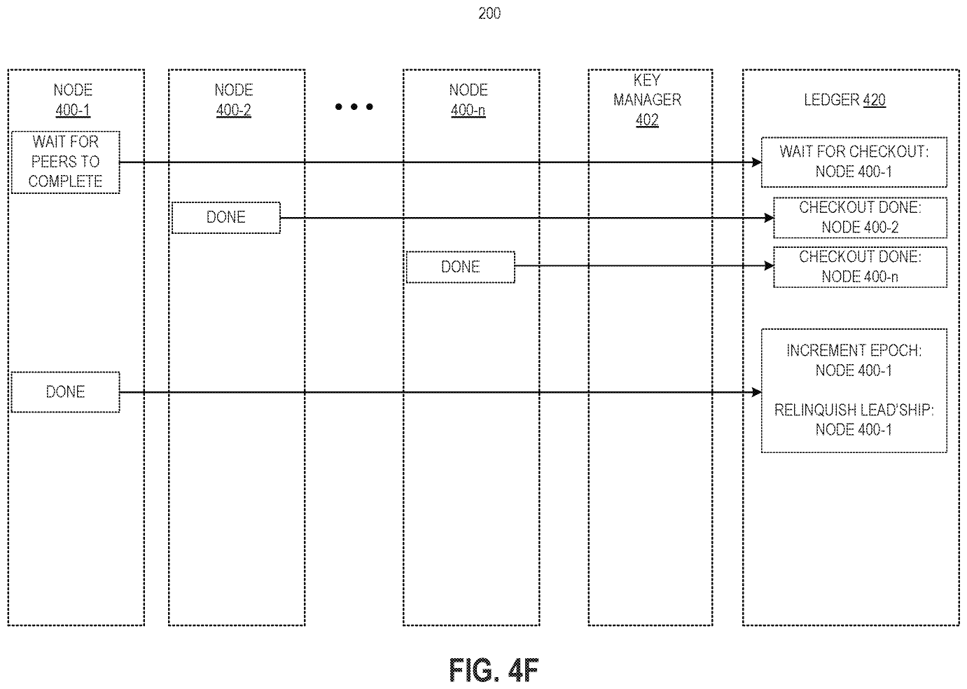

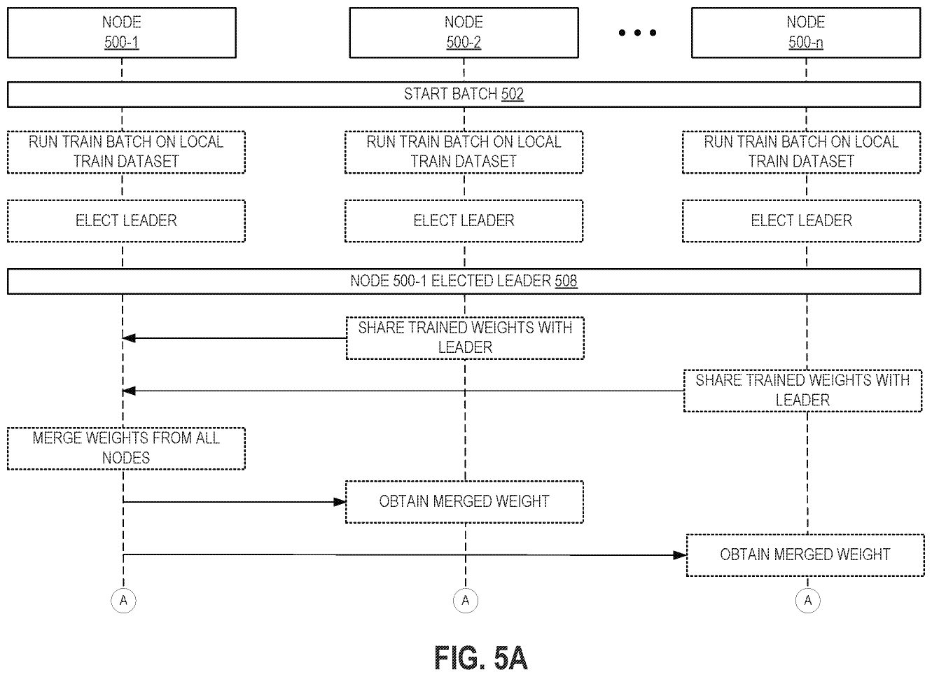

The blockchain agent 52 may use the blockchain interface layer 30 to communicate with other edge nodes 10 and/or management node 12, The blockchain interface layer 30, described with reference to FIG. 4, may operate in the same manner at management node 12 and edge node 10 to communicate with the blockchain network (other than being able to write to the distributed ledger 42). For example, the blockchain agent 52 may obtain an updated copy of the distributed ledger 42 from one or more other edge nodes 10 and/or management node 12. The blockchain agent 52 may also obtain management operations from the distributed ledger 42 written by the management node 12, In this manner, the management node 12 may communicate management operations to be performed at an edge node 10 through the distributed ledger 42.

The configuration manager 54 may obtain one or more management operations from the blockchain agent 52, The configuration manager 54 may apply the one or more management operations to the edge node 10. In some instances, the configuration manager 54 may apply the management operations without a determination of whether to do so. In other instances, the configuration manager 54 may consult one or more local policies to ensure that the edge node 10 can comply with the one or more management operations. The local policies may be encoded by the smart contracts 44. Alternatively or additionally, some local policies may be stored in a local policy 78, which is not necessarily shared with other edge nodes 10, In other words local policy 78 may be defined specifically at an edge node at which it is stored.

Once the configuration manager 54 has acted on the one or more management operations (whether by applying them or not), the blockchain agent 52 may broadcast its state to other nodes of the blockchain network 110. For example, the blockchain agent 52 may generate and transmit a blockchain transaction that indicates the state of the edge node 10 (such as whether, how, and/or when the one or more management operations have been applied). The blockchain transaction may include information identifying the management operation was (or was not) performed. For example, the information identifying the management operation may be a block identifier (such as a block hash) that identifies the block from which the management operations was obtained. In this manner, the blockchain transaction indicating a node's state may record the management operation that was (or was not) applied.

For implementations in which management operations are targeted to an edge node 10 and encrypted using the targeted edge node 10's public key 72, the blockchain agent 52 may decrypt the management operations using the edge node 10's private key 74. In some implementations, the blockchain agent 52 may digitally sign a blockchain transaction from the management node 12 that includes the management operation. For instance, the management node 12 may generate a transaction directed to the edge node 10 and sign the transaction using the management node 12's public key.

The management node 12 may then write the signed transaction to the distributed ledger 42 to create an immutable record of the management operation and state change of the targeted edge node. In this manner, the transaction may be securely proven to have been executed by the edge node 10. It should be noted that the edge node 10 need not specifically be targeted in order to sign the transaction so as to create a record of the edge node's 10 state in a transaction and therefore block.

Upon receipt of a transaction, the edge node 10 apply the management operation and indicate that it has successfully done so by signing the transaction with the edge node's private key. The management node 12 may write this transaction into the distributed ledger 42, creating a secure, immutable record that proves that the edge node received and applied the management operation. In some implementations, an edge node 10 may be associated with a series of transactions such that each transaction may refer to a previous transaction hash. The transactions may be written to the distributed ledger 42 by the management node 12, creating an immutable and historic record of transactions for a given edge node 10.

In an implementation, the configuration manager 54 may periodically ensure compliance with the current state of the system. For instance, the smart contracts 44 may encode rules that specify what events trigger such checking. The events may include a restart, a new initialization, a passage of a period of time, a number of blocks written to the distributed ledger 42, a security event such as detection of malware, an input from a user specifying that the check should occur, and/or other event that can trigger compliance evaluation. To evaluate compliance, the configuration manager 54 may determine whether any current management operations (as defined by the latest block encoding such operations), including global ones and those specifically targeted to the edge node 10. If so, the configuration manager 54 may determine whether they should have been but were not implemented. If not, the configuration manager 54 may implement the management operations. In this manner, the edge nodes 10 may self-enforce the current management operations (as defined by the current system state).

The storage devices 70 may store an edge node's copy of the distributed ledger 42, the edge node's copy of smart contracts 44, the edge node's public key 72, the edge node's private key 74, and/or other data.

Reference will now be made to FIG. 1D, which illustrates an example of the blockchain interface layer 30. Each of the edge nodes 10 and the management node 12 may implement the blockchain interface layer 30, except that the edge nodes 10 may not have permission to write to the distributed ledger 42. The blockchain interface layer 30 may include a messaging interface used to communicate with the blockchain network 110. The messaging interface may be configured as a Secure Hypertext Transmission Protocol (“HTTPS”) microserver 31. Other types of messaging interfaces may be used as well. The blockchain interface layer 30 may use a blockchain API 32 to make calls for blockchain functions based on a blockchain specification. Examples of blockchain functions include, but are not limited to, reading and writing blockchain transactions 34 and reading and writing blockchain blocks to the distributed ledger 42. One example of a blockchain specification is the Ethereum specification. Other blockchain specifications may be used as well. Consensus engine 36 may include functions that make consensus decisions, such as whether to enroll a node to participate in decentralized management of the edge nodes. The state of a node 10 can be reflected by state 38.

Although illustrated in FIGS. 1B and 1C as a single component, a management node 12 or edge node 10, respectively, may include a plurality of individual components (such as computer devices) each programmed with at least some of the functions described herein. The one or more processors 20 or 50 may each include one or more physical processors that are programmed by computer program instructions. The various instructions described herein are provided for illustrative purposes. Other configurations and numbers of instructions may be used, so long as the processor(s) 20 or 50 are programmed to perform the functions described herein.

Furthermore, it should be appreciated that although the various functions are illustrated in FIGS. 1B and 1C as being co-located within a single processing unit, in implementations in which processor(s) 20 or 50 includes multiple processing units, one or more instructions may be executed remotely from the other instructions.

The various instructions for performing various functions described herein may be stored in a storage device 40 or 70, which may comprise random access memory (RAM), read only memory (ROM), and/or other memory. Storage device 40 or 70 may store the computer program instructions (such as the aforementioned instructions) to be executed by processor 20 or 50, respectively, as well as data that may be manipulated by processor 20 or 50. Storage device 40 or 70 may comprise one or more non-transitory machine-readable storage media such as floppy disks, hard disks, optical disks, tapes, or other physical storage media for storing computer-executable instructions and/or data.

The distributed ledger 42, transaction queue, smart contracts 44, management operations to be performed, and/or other information described herein may be stored in various storage devices such as storage device 40 or 70. Other storage may be used as well, depending on the particular storage and retrieval requirements. For example, the various information described herein may be stored using one or more databases. The databases may be, include, or interface to, for example, an Oracle™ relational database sold commercially by Oracle Corporation. Other databases, such as Iniormix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The edge nodes 10 and management node 12 illustrated in FIGS. 1C and 1B, respectively, may be coupled to other nodes via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1A, as well as in other figures, different numbers of entities than those depicted may be used. Furthermore, according to various implementations, the components described herein may be implemented in hardware and/or software that configure hardware.

Swarm learning can involve various stages or phases of operation including, but not limited to: initialization and onboarding; installation and configuration; and integration and training. Initialization and onboarding can refer to a process (that can be an offline process) that involves multiple entities interested in Swarm-based ML to come together and formulate the operational and legal requirements of the decentralized system. This includes aspects such as data (parameter) sharing agreements, arrangements to ensure node visibility across organizational boundaries of the entities, and a consensus on the expected outcomes from the model training process. Values of configurable parameters provided by a swarm learning network, such as the peer-discovery nodes supplied during boot up and the synchronization frequency among nodes, are also finalized at this stage. Finally, the common (global) model to be trained and the reward system (if applicable) can be agreed upon.

Once the initialization and onboarding phase is complete, all participants (edge nodes 10, for example) may download and install a swarm learning platform/application onto their respective machines, i.e., nodes. The swarm learning platform may then boot up, and each node's connection to the swarm learning/swarm-based blockchain network can be initiated. As used herein, the term swarm learning platform can refer to a blockchain overlay on an underlying network of connections between nodes. The boot up process can be an ordered process in which the set of nodes designated as peer-discovery nodes (during the initialization phase) are booted up first, followed by the rest of the nodes in the swarm learning network.

With regard to the integration and training phase, the swarm learning platform can provide a set of APIs that enable fast integration with multiple frameworks. These APIs can be incorporated into an existing code base for the swarm learning platform to quickly transform a stand-alone ML node into a swarm learning participant. It should be understood that participant and node may be used interchangeably in describing various embodiments.

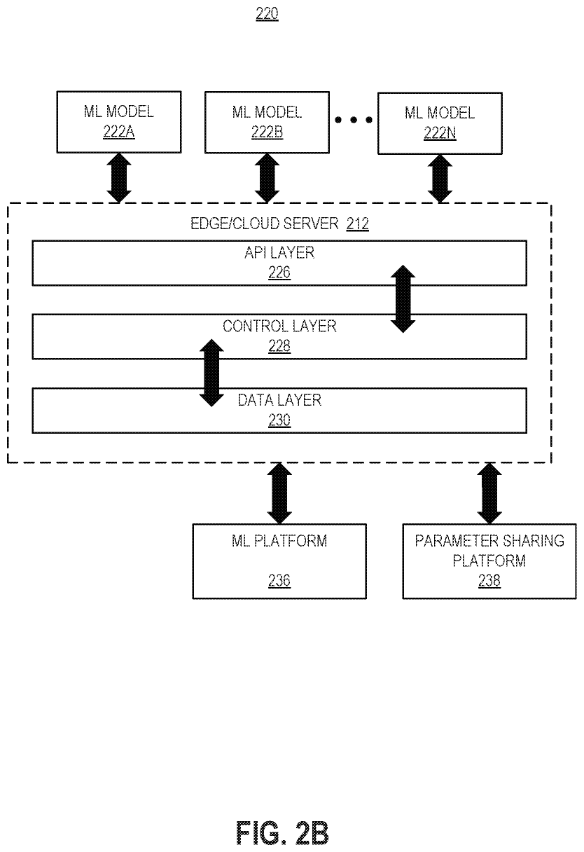

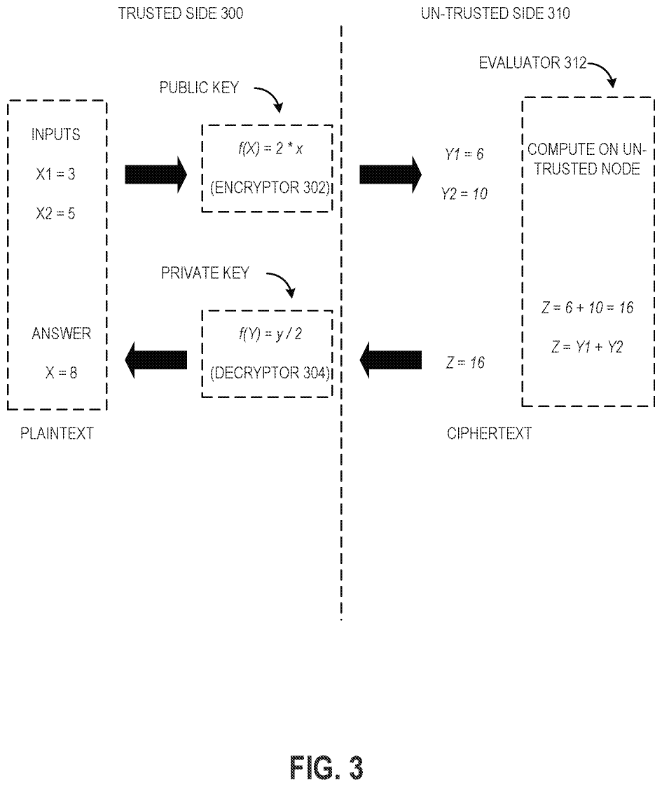

At a high level, model training in accordance with various embodiments may be described in terms of enrollment, local model training, parameter sharing, parameter merging, and stopping criterion check. FIG. 2A illustrates operations that can be performed by the swarm learning platforms accordance with one embodiment. At 200, enrollment occurs. That is, each node in the swarm learning network may enroll or register itself in a swarm learning contract. In one embodiment, this can be a one-time process. In other embodiments, enrollment or registration may be performed after some time as a type of verification process. Each node can subsequently record its relevant attributes in the swarm learning contract, e.g., the uniform resource locator (URL) from which its own set of trained parameters can be downloaded by other nodes.

At 202, local model training occurs, where each node proceeds to train a local copy of the global or common model in an iterative fashion over multiple rounds that can be referred to as epochs, During each epoch, each node trains its local model using one or more data batches for some given number of iterations. A check to determine if parameters can be merged may be performed at 204. The check can determine if the threshold number of iterations has been reached and/or whether a threshold number of nodes are ready to share their respective parameters. These thresholds can be specified during the initialization phase. After the threshold number of iterations has been reached, the parameter values of each node are exported to a file, which can then be uploaded to a shared file system for other nodes to access, Each node may signal the other nodes that it is ready to share its parameters.

Once parameter sharing commences, current model parameters may be exported at 206 and the exported parameters can be sent to a swarm learning application programming interface (API) (described in greater detail below) at 208. The parameter sharing phase can begin with the election of a merge or epoch leader, whose role is to merge the parameters derived after local training on the common model at each of the nodes. This election of a merge or epoch leader can occur after each epoch. While it is possible to elect a node to act as the merge leader across multiple epochs, electing a merge leader after each epoch helps ensure privacy by changing which node has the public key. Upon selection of one of the nodes of the swarm learning network to be the merge leader, the URL information of each participant or node can be used to download the parameter files from each node. In one embodiment, a star topology can be used, where a single merge leader performs the merge. Other topologies, such as a k-way merge, where the merge is carried out by a set of nodes may also be used.

The merge leader may then merge the downloaded parameter files (from each swarm learning network node). Appropriate merge mechanisms or algorithms may be used, e.g., one or more of mean merging, weighted mean merging, median merging, etc. The merge leader may combine the parameter values from all of the nodes to create a new file with the merged parameters, and signals to the other nodes that a new file is available. At 210, each node may obtain the merged parameters (represented in the new file) from the merge leader via the swarm API. At 212, each node may update its local version of the common model with the merged parameters.

At 214, a check can be performed to determine if a stopping criterion has been reached. That is, each of the nodes evaluate the model with the updated parameter values using their local data to calculate various validation metrics. The values obtained from this operation are shared using a smart contract state variable. As each node completes this step, it signals to the swarm learning network that the update and validation step is complete. In the interim, the merge leader may keep checking for an update complete signal from each node. When it discovers that all merge participants have signaled completion, the merge leader merges the local validation metric numbers to calculate global metric numbers. This updating of the model can be thought of as a synchronization step. If the policy decided during initialization supports monetization during model building, the rewards corresponding to the contributions by each of the participants are calculated and dispensed at this point. Afterwards, the current state of the swarm learning network is compared against a stopping criterion, and if it is found to be met, the swarm learning process ends. Otherwise, the steps of local model training, parameter sharing, parameter merging, and stopping criterion check are repeated until the criterion is fulfilled.

FIG. 2B illustrates an example swarm learning architecture 220. This swarm learning architecture 220 may include local ML models 222A-222N at each node (ML models 1, 2, . . . N). These local ML models 222A-222N may be maintained and trained at nodes making up the swarm learning network, e.g., edge nodes 10, described above that make up blockchain network 110. The swarm learning architecture 220 may also include a swarm learning component 224 which may include an API layer 226, a control layer 228, a data layer 230, and a monetization layer 232. The swarm learning component 224 may operate (as noted above) in a blockchain context to ensure data privacy where a blockchain platform 234 operates on top of a ML platform 236 (that is distributed amongst nodes of a swarm learning network). The sharing of parameters and validation loss values can be performed using a blockchain ledger 238, which may be an embodiment of distributed ledger 42. It should be noted the components or elements of swarm learning architecture 220 can be modular so that the technologies used in implementing them can be replaced, adjusted, adapted, etc. based on requirements. The entire framework is designed to run on both commodity and high-end machines, supporting a heterogeneous set of infrastructure in the swarm learning network. It can be deployed within and across data centers, and has built-in support for a fault-tolerant network, where nodes can exit and reenter the swarm learning network dynamically without derailing or stalling the model building process. In other words, blockchain platform 234 is used as an infrastructure component for implementing a swarm learning ledger (or blackboard) which encompasses the decentralized control logic for ML model building, HE key sharing, and parameter sharing logic. Edge nodes 10 (where ML models 222A, 222B . . . , 222N are trained) may themselves have all the infrastructure components and control logic used for controlling/managing swarm learning.

Swarm learning, in one embodiment, can be implemented as an API library 226 available for multiple popular frameworks such as TensorFlow, Keras, and the like. These APIs provide an interface that is similar to the training APIs in the native frameworks familiar to data scientists. Calling these APIs automatically inserts the required “hooks” for swarm learning so that nodes seamlessly exchange parameters at the end of each model training epoch, and subsequently continue the training after resetting the local models to the globally merged parameters.

Responsibility for keeping the swarm learning network in a globally consistent state lies with the control layer 228, which is implemented using blockchain technology. The control layer 228 ensures that all operations and the corresponding state transitions are performed in an atomic manner. Both state and supported operations are encapsulated in a blockchain smart contract. The state (38 of FIG. 1D) comprises information such as the current epoch, the current members or participants of the swarm learning network, along with their IP addresses and ports, and the URIs for parameter files. The set of supported operations includes logic to elect a merge leader of the swarm learning network toward the end of each epoch, fault-tolerance, and self-healing mechanisms, along with signaling among nodes for commencement and completion of various phases.

Data layer 230 controls the reliable and secure sharing of model parameters and validation loss values across the swarm learning network. Like control layer 228, data layer 230 is able to support different file-sharing mechanisms, such as hypertext transfer protocol secure (HTTPS) over transport layer security (TLS), interplanetary file system (IPPS), and so on. Data layer 230 may be controlled through the supported operations invoked by control layer 228, where information about this layer may also be maintained.

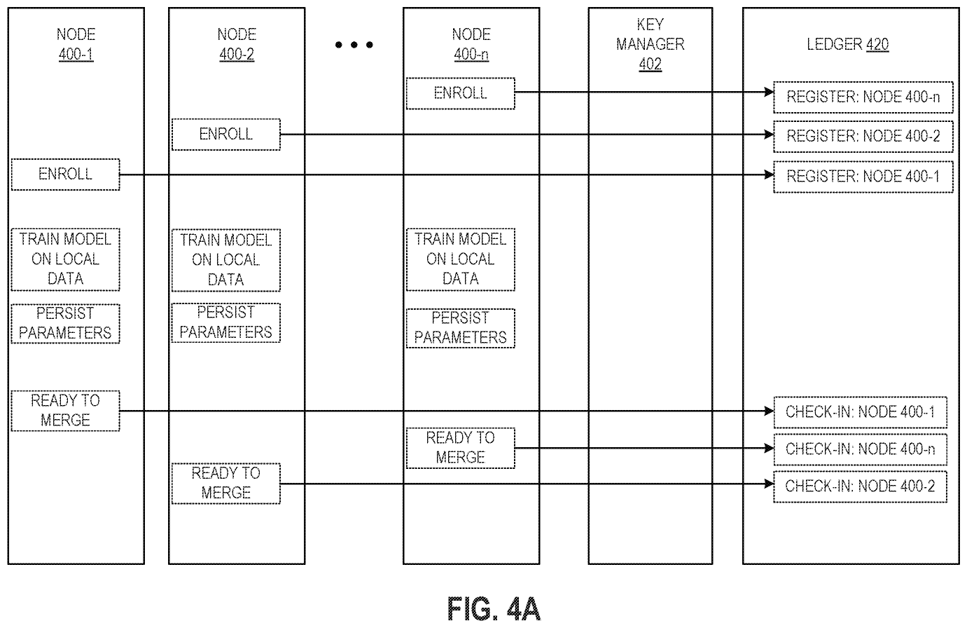

FIG. 3 illustrates an example of homomorphic encryption. Homomorphic Encryption (HE) can refer to a subset of techniques to implement a trusted computing environment by allowing particular computations to be executed on ciphertexts, obtain an encrypted result that is the ciphertext of the result of operations performed on the plaintext. Here, the trusted side 300 includes encrypting with an encryptor 302, plaintext input values, using an encryption function, as well as decrypting with a decryptor 304, ciphertext received from the un-trusted side 310 using a private key resulting in a plaintext answer, Here, asymmetric key encryption, i.e., the use of private and public keys, can be leveraged to avoid sharing a common secret with any of the participants. In addition, HE may rely on an evaluator 312 (in un-trusted side 310) that executes evaluations operations, e.g., a pre-defined and proven set of operations such as addition, multiplication, etc. on homomorphically encrypted data. That is, evaluator 312 may receive encrypted versions of the plaintext input values, and perform the operation in ciphertext, in this case, addition. Because evaluator 312 operates only on encrypted data (ciphertext), evaluator 312 can be run on a non-trusted system, i.e., on the un-trusted side 310.

As alluded to above, various embodiments are directed to preventing any participant/node in the swarm learning network from gaining access to all of the parameter data or validation loss information in plaintext, or all of the shared secrets at any point in the parameter and validation loss value merging process, ensuring that even a merge leader cannot decrypt incoming parameter data or local validation loss values. Further, the asymmetric keys will be generated by a key manager (external to the swarm learning network). The key manager is not part of the swarm learning “core” architecture (but rather a service relied upon to implement swarm learning). The key manager can be an enterprise grade key manager that generates and serves public/private keys from a fault tolerant and physical secure environment. For example, a key manager may be specialized and hardened hardware/software co-designed applications. As noted above, the key manager releases only the public key to the merge leader to be published to participants for encrypting their local parameter data and local validation loss values, and parameter/validation loss value merging is performed homomorphically. Decryption of merged parameters/merged validation loss values can be executed by an elected decryptor node that is not the merge leader. This decryptor node can request a private key from the key manager to decrypt the merged parameters/local validation loss values and supply it to the merge leader for distribution.

FIGS. 4A-4F illustrate example operations that can be performed to effectuate swarm learning using homomorphic encryption to protect parameter data in accordance with one embodiment of the disclosed technology.

Referring to FIG. 4A, the swarm learning process may, in one embodiment, begin with the election of a merge leader when a quorum of nodes (nodes 400-1 to 400-n in the swarm network, which can be an embodiment of blockchain network 110, are ready merge their parameters. As illustrated in FIG. 4A, each of nodes 400-1, 400-2 . . . , 400-n perform an enroll operation resulting in each of nodes 400-1, 400-2 . . . , 400-n being registered in ledger 420, which may be an embodiment of ledger 42 or ledger 238 discussed above. It should be understood that the smart contracts 44, described above, may encode rules for enrolling a node for participation in a swarm learning network, e.g., an embodiment of blockchain network 110. The rules may specify required credentials and/or other enrollment prerequisites. The required credentials may impose permissions on which nodes are allowed to participate. For example, the blockchain network 110 may be configured as a private blockchain where only authorized nodes are permitted to participate in an iteration. Moreover, any authorization information and expected credentials may be encoded within the smart contracts 44 or other stored information available to nodes on the blockchain network 110, Once a node has been enrolled, the blockchain network 110 may record an identity of the node and its state so that an identification of all nodes is known. Such recordation may be made via an entry in the distributed ledger 420. As such, the distributed ledger 420 may record a topology of the nodes and a state of the nodes, and this may continue through the parameter merging process as will be described further below.

As further illustrated in FIG. 4A, each of nodes 400-1, 400-2 . . . , 400-n can train instances of a common, global model using local data present/contributed by each of the nodes. As noted above, parameters, e.g., weights, can be derived pursuant to the training of the model using local data, and these parameters may then be persisted in their encrypted state or format. Upon completion of model training and persisting the parameters derived therefrom, each of nodes 400-1, 400-2 . . . , 400-n are ready to merge their particular parameters with those of the other nodes. Accordingly, this ready to merge state may be reflected in ledger 420 by writing to ledger 420, a checked-in entry associated with each of nodes 400-1, 400-2 . . . , 400-n.

Referring to FIG. 4B, each of nodes 400-1, 400-2 . . . , 400-n go through an election process to select one of the nodes to act as a merge leader. Election votes are recorded in ledger 420. As noted above, ledger 420 can reflect a record of a node's state as well as its identity, so votes can be associated with the nodes submitting those votes, and a node selected, in this example, to be a merge leader (and later, a decryptor) can be made aware of its state/elected role. In some embodiments, each node uses agreed-upon voting/election logic, the winner of which is elected as the merge leader. For example, each node may randomly select a number that it registers in ledger 420, and the node registering the lowest number (or highest number, or closest to a defined number, etc.) can be used as a basis for election. Those having ordinary skill in the art would be aware of different election mechanism that can be implemented in this context. Once votes are recorded in ledger 420, each of nodes 400-1, 400-2 . . . , 400-n queries ledger 420 to determine if it has been selected to be the merge leader. In this example, node 400-1 happens to have been selected, at which point, it may start the parameter merging process by first asking key manager 402 to generate a public/private key pair. Upon generating the requested public/private key pair, key manager transmits the public key to node 400-1. In the meantime, each of the other nodes, nodes 400-2 to 400-n enter into a wait state until the public key generated by key manager 402 is published to ledger 420 by node 400-1, elected to be the merge leader. In some embodiments, the merge leader may signal to the other nodes that the public key has been published. In the present disclosure, the signaling may be accomplished by invoking methods in smart contracts that alter a common shared state in ledger 420.

Referring now to FIG. 4C, each of nodes 400-1, 400-2 . . . , 400-n encrypts its persisted parameters using the public key generated by key manager 402 and published by the elected merge leader, which in this example, is node 400-1. The reading of the public key by each of nodes 400-2 . . . , 400-n may be written to ledger 420. It should be understood that because node 400-1 was elected to be the merge leader, and because key manager 402 responded to a public/private key request from node 400-1 by transmitting the generated public key to node 400-1, node 400-1 is already in possession of the public key.

As described above with respect to FIG. 3, an encryptor, such as encryptor 302, may be a complex function, and the public key becomes a parameter of that complex function, hence the ability to derive a parameter based on training the common, global model at each node. It should be understood that X1 and X2 can be equated to plaintext parameters sent by an individual node. Y1 and Y2 are encrypted parameters, and Z refers to a merged parameter derived by performing a homomorphic addition operation (adding and Y2). Z is also encrypted and is eventually decrypted to obtain the final merged parameter X. Upon each of nodes 400-1, 400-2 . . . , 400-n completing their respective parameter encryption processes, each of nodes 400-1, 400-2 . . . , 400-n writes their status, i.e., ready to merge state, to ledger 420. Ledger 420 records this as a check-in, similar to when each of the nodes 400-1, 400-2 . . . , 400-n indicates readiness to merge their respective persisted parameters prior to encryption. Because in this example, node 400-1 is acting as the merge leader, nodes 400-2 . . . , 400-n enter into a “wait for merge” state until node 400-1 is ready to perform the (encrypted) parameter merging. In some embodiments, nods 400-2 . . . , 400-n signal their respective readiness to merge to node 400-1. When all the remaining nodes, in this example, nodes 400-2 . . . , 400-n are ready to merge, node 400-1 downloads the encrypted, persisted parameters from each of nodes 400-2 . . . , 400-n and performs the merge to arrive at a final merged parameter, and when the merge is complete, node 400-1 writes to ledger 420 that the merged parameter is ready. As used herein, a merge, such as parameter merge can refer to a mathematical weighted averaging operation that outputs a single parameter derived through this mathematical weighted averaging operation based on input parameters.

With regard to nodes providing their respective state, each node may record its own state in ledger 420. For example, a node, such as node 400-2 recording the fact that it has read the public key published by the merge leader, i.e., node 400-1, provides an indication to the other nodes that a particular operation (in this case reading of the public key) was performed, and if so, whether it was successfully performed. Node 400-2 may write its state to a transaction that is shared to other nodes in the blockchain network 110 using the blockchain API 32. The management node 12 may obtain the transactions and mine them into the distributed ledger 420 using the blockchain API 32. Doing so creates an undisputable, tamperproof provenance of the global state of the blockchain network 110, which, as used herein, reflects the global state of the parameter/merging/swarm learning status amongst nodes 400-1, 400-2 . . . , 400n. Moreover, each node is aware of the full state of the swarm learning network from their local copy of the distributed ledger 420. This allows any node to take globally valid decisions based on local data, as well as scale to add new nodes or account for restarting nodes that need to synchronize to the current state of the swarm learning network.

It should be understood that the above-described phase ensures full protection of the local, node-specific parameters prior to them being merged. Also, by distributing the compute-intensive encryption process to each of the participating nodes, scaling bottlenecks are avoided. Furthermore, the algorithm ensures complete data privacy as none of the nodes including the merge leader will ever have parameters from another peer in plaintext. It should also be noted that the aforementioned, final merged parameter comprises a homomorphic summation of the individual, encrypted and persisted parameters, which is then followed by a scalar multiplication with a 1/QuorumSize floating point constant. Since the merge process uses basic homomorphic operators, this algorithm can be implemented with most any existing/available HE package. It should be understood that HE schemes typically only allow certain types of mathematical operations to be performed on data. For example, many popular ME schemes have addition and scalar multiplication defined. Therefore, for simplicity/efficiency, parameter merging as described herein can be made to rely on these basic operations. In other words, known HE schemes can be leveraged without altering their logic. Since the merge process uses basic homomorphic operators, this algorithm can be implemented with most any existing/available HE scheme or package, e.g., RSA, EIGamal, Goldwasse-Micali, etc. Once the merge operation is done the merge leader signals other nodes that the merged parameter as ready for decryption.

Referring now FIG. 4D, each node (other than the merge leader, node 400-1), upon reading the merge ready signal recorded in ledger 420, engages in a decryptor election process. As illustrated in FIG. 4D, the reading of the merge ready signal may also be recorded by ledger 420, and similar to the election process described above for electing the merge leader, a decryptor is elected. Votes for a particular node to act as the decryptor are written to ledger 420. The merge leader, node 400-1 in this example, is purposely excluded from the decryptor election process to ensure it cannot be selected so that it will not be privy to the private key used to decrypt the final merged parameter. Recall that part of the security afforded by various embodiments of the disclosed technology is premised on the fact that no one participant or node knows both the public and private keys. In this example, node 400-2 has been elected to act as the decryptor, and once this election occurs, the remaining nodes enter a “wait for merged parameter” state. The decryptor, in this case, node 400-2, requests the private key generated by key manager 402 in response to the previous request from the merge leader, node 400-1. Key manager 402 responds to node 400-2 by sending the corresponding private key to node 400-2. Again, rude 400-1, which has/had the public key used for encrypting will not be privy to the corresponding private key, preventing node 400-1 from decrypting any parameter data. Moreover, node 400-2, the decryptor is not privy to any other local parameters or parameter data from any other nodes because node 400-1 was the elected merge leader. Node 400-2 generates the merged parameter by decrypting Z (the encrypted version of the merged parameters) that is converted to X (the decrypted version of the merged parameter).

Referring to FIG. 4E, the decryptor, i.e., node 400-2, downloads the merged parameter from the merge leader, i.e., node 400-1, decrypts the merged parameter, and uploads the now-decrypted merged parameter back to the merge leader, and requests that key manager 402 discard the public/private key pair permanently. Key manager 402 in response, discards the public/private key pair. This ensures that no other nodes, including the merge leader, can request the private key to decrypt the parameters from another node. The decryptor signals the merge parameter is ready and is available with the merge leader as evidence by ledger 420 being updated to record the transaction of uploading/publishing of the decrypted, merged parameter by node 400-1. In other words, upon uploading the decrypted, merged parameter to the merge leader (node 400-1), the merge leader makes the decrypted, merged parameter available to the other nodes. The remaining nodes, other than node 400-2 (because it is already aware of the merged parameter) read the merged parameter by downloading it from node 400-1, All the nodes 400-1, 400-2 . . . , 400-n may now apply the merged parameter locally to their respective local instances of the common, global model. It should be understood that application of a merged parameter can refer to overwriting parameters that were externally supplied, in this case, the final merge parameter overrides the local parameters at each of nodes 400-1, 400-2 . . . , 400-n.

As illustrated in FIG. 4F, node 400-1 waits for the other nodes to complete application of the merged parameter to their respective local instances of the common, global model, which can be reflected in ledger 420. When all the nodes are done applying the merged parameter, the nodes may also signal completion in ledger 420, at which point, node 400-1, the merge leader, records an increment to the epoch number/value and relinquishes its role as the merge leader. As noted above, this parameter merging process can be repeated until the swarm learning network is able to converge the global model to a desired accuracy level.

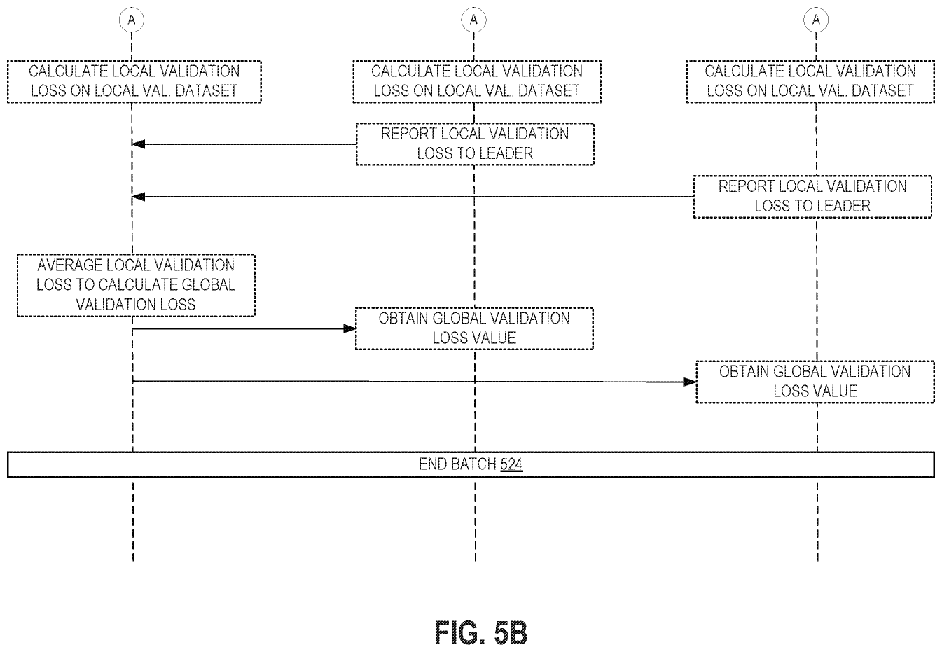

FIGS. 5A and 5B illustrate various operations that may be performed to calculate a validation loss for models in a distributed or decentralized ML system. As noted above, each participating node may train a local version/instance of a model using data local to each participating node. Periodically, the weights derived from the locally-trained models can be merged to derive the weights for a global model. The merged weights can then be applied back by each node on their respective local models to be used a “base” model for training during subsequent training iterations or epochs.

For example, FIG. 5A illustrates three nodes, node 500-1, node 500-2, and node 500-n. Nodes 500-1, 500-2, . . . , 500-n may be embodiments of an edge node 10 (FIG. 1A) or nodes 400-1, 400-2, etc. As illustrated in FIG. 5A, batch training 502 may commence across each of nodes 500-1, 500-2 . . . , 500-n. It should be noted that “batch” can refer to a subset of training data used to run one training iteration of the ML model. Typically, batch size is taken to be about 16 or 32 training examples at a time, but this is merely an example. As would be understood by those of ordinary skill in the art, a ML model can be trained iteratively over multiple batches until it is satisfactorily trained or is no longer improving in its performance. Training of the local versions of the common, global model at each of nodes 500-1, 500-2, . . . , 500-n occurs as described previously. However, it should be noted that prior to the start of batch training 502, the respective local datasets at each of nodes 500-1, 500-2 . . . , 500-n may be split or otherwise partitioned into a training dataset and a validation dataset. That is, a first subset of the local data can be used for training the local version of the model, where a second subset of the local data can be used for validation purposes to determine how well (or how poorly) a model is performing.

Accordingly, as reflected in FIG. 5A, each of nodes 500-1, 500-2 . . . , 500-n run a training batch on each node's respective local training dataset. It should be understood that this batch training refers to the training of a model on local data referred to above and described in FIG. 4A. That is, each of nodes 500-1, 500-2 . . . , 500-n can train instances of a common, global model using local data present/contributed by each of the nodes. As noted above, parameters, e.g., weights, can be derived pursuant to the training of the model using local data, and these parameters may then be persisted in their encrypted state or format.

A merge leader is elected (as described above) for the purposes of merging local parameters from training local versions of the global model at each node, and subsequently, to handle respective validation loss values from each node. Accordingly, each of nodes 500-1, 500-2 . . . , 500-n elect a leader. As described above, leader election can entail each of nodes 500-1, 500-2 . . . , 500-n going through an election process to select one of the nodes to act as a merge leader. Election votes to elect one of the participating nodes as a leader may be recorded in a blockchain ledger that reflects a record of a node's state as well as its identity, so votes can be associated with the nodes submitting those votes, and a node selected, in this example, to be a merge leader (and later, a decryptor) can be made aware of its state/elected role. Again, each node may use agreed-upon voting/election logic, the winner of which is elected as the leader. In this example, node 500-1 may be elected at 508 to act as the leader.

Once a leader is selected, local parameter/weights sharing can progress as described above with respect to FIGS. 4B and 4C. That is, with node 500-1 having been elected leader, node 500-1 may start the parameter merging process by first asking a key manager to generate a public/private key pair. The key manager may transmit the public key to node 500-1. In the meantime, each of the other nodes, nodes 500-2 to 500-n enter into a wait state until the public key generated by key manager is published by node 500-1.

Each of the nodes 500-1, 500-2 . . . , 500-n may then encrypt their respective persisted parameters using the public key generated by the key manager and published by the elected leader, which in this example, is node 500-1. As described above, node 500-1 is already in possession of the public key, and can encrypt its local parameters. Upon each of nodes 500-1, 500-2 . . . , 500-n completing their respective parameter encryption processes, each of nodes 500-1, 500-2, . . . , 500-n indicates their readiness to share their respective parameters. Sharing their respective parameters can be accomplished by node 500-1, the elected leader, d loading the encrypted, persisted parameters from each of nodes 500-2 . . . , 500-n. Node 500-1 may then merge the parameters(weights) to arrive at a final merged parameter (weight), Again, a parameter merge can refer to a mathematical weighted averaging operation that outputs a single parameter derived through this mathematical weighted averaging operation based on input parameters.

As further illustrated by FIG. 5A, the elected leader, in this case, node 500-1, may distribute the merged parameter (weight) to the participating nodes, 500-2 . . . , 500-n. Because the merged parameter is achieved using encrypted local parameters (weights), they must be decrypted. Accordingly, the remaining nodes (not node 500-1, that was already elected a leader for purposes of merging parameters (weights)) engage in a decryptor election process. For example, node 500-2 may be elected to act as the decryptor, which can request the private key generated by the key manager, and then generate the merged parameter by decrypting the encrypted version of the merged parameter (weight) generated by node 500-1 to the decrypted version of the merged parameter (weight). In particular, node 500-2 may download the merged parameter from the elected leader, i.e., node 500-1, decrypts the merged parameter. Node 500-2 may upload the now-decrypted merged parameter back to the node 500-1, and requests that the key manager discard the public/private key pair it generated permanently (which the key manager does). This ensures that no other nodes, including the leader, can request the private key to decrypt the parameters from another node. The decryptor, node 500-2, signals the merged parameter (weight) is ready and is available with the leader, node 500-1. The remaining nodes, other than node 500-2 (because it is already aware of the merged parameter/weight) may obtain the merged parameter (weight) by downloading it from node 500-1. All the nodes 500-1, 500-2 . . . , 500-n may now apply the merged parameter locally to their respective local instances of the common, global model. As noted above, the application of a merged parameter can refer to overwriting parameters (weights) that were externally supplied, in this case, the final merge parameter (weight) overrides the local parameters at each of nodes 500-1, 500-2 . . . , 500-n.

As noted above, this parameter merging process can be repeated until the swarm learning network is able to converge the global model to a desired accuracy level. As part of determining whether the global model is able to achieve a desired accuracy level, the validation loss may be calculated. As alluded to above, validation may be performed locally, the local validation loss of each node can be shared, and an average of the local validation loss can be calculated to derive a global validation loss. This global validation loss may be shared with each node so that each node may determine how well its local model is performed/has been trained from a network or system-wide (global) perspective.

Fla 58 continues with various operations that may be performed to calculate a validation loss for models in a distributed or decentralized ML system. As illustrated in FIG. 58, each of nodes 500-1, 500-2 . . . , 500-n may calculate a local validation loss. The local validation loss can be calculated using each nodes' local validation dataset. Recall that prior to beginning a training iteration, each node may partition its local dataset into a training data subset and a validation data subset. Calculation of the local validation loss can be effectuated using methods currently known or that may be known in the future. For example, the model can be run over the validation data subset, after which, the output can be compared with ground truth values using a loss function. Each node 500-1, 500-2 . . . , 500-n will arrive at a local validation loss value that can then be shared with the elected leader.

As described above, the elected leader, i.e., node 500-1, was previously selected to act as a merge leader for merging local parameters (weights) derived from training each local instance of the common, global model, at each node (using the training data subset). The same elected leader can act to calculate an average validation loss across all the nodes to arrive at a global validation loss. Thus, as illustrated in FIG. 5B, each of nodes 500-2, . . . , 500-n reports its local validation loss value to node 500-1 (which is aware of its own calculated local validation loss value).

It should be understood that although not necessarily needed, the local validation loss values of each of nodes 500-1, 500-2 . . . , 500-n may be homomorphically encrypted in the same way the local parameters (weights) are encrypted. That is, node 500-1, the elected leader, may request that the key manager generate another public/private key pair to be used to encrypt and decrypt the local validation loss values and the global validation loss value, respectively.

For example, in response to node 500-1 asking the key manager to generate a public/private key pair, the key manager may transmit the public key to node 500-1. In the meantime, each of the other nodes, nodes 500-2 to 500-n enter into a wait state until the public key generated by key manager is published by node 500-1. Each of the nodes 500-1, 500-2 . . . , 500-n may then encrypt their respective local validation loss values using the public key generated by the key manager and published by node 500-1. As described above, node 500-1 is already in possession of the public key, and can encrypt its local validation loss value. Upon each of nodes 500-1, 500-2 . . . , 500-n completing their respective validation loss value encryption processes, each of nodes 500-1, 500-2 . . . , 500-n indicates their readiness to share their respective validation loss values. Sharing their respective validation loss values can be accomplished by node 500-1, the elected leader, by downloading the encrypted validation loss values from each of nodes 500-2 . . . , 500-n. Node 500-1 may then average the encrypted validation loss values from each of nodes 500-2 . . . , 500-n along with its own validation loss value to arrive at a global validation loss value. Similar to the parameter merge described above, averaging the local validation loss values can be calculated using a mathematical weighted averaging operation that outputs a single parameter derived through this mathematical weighted averaging operation based on input parameters.

As further illustrated by FIG. 5B, the elected leader, in this case, node 500-1, may distribute the global validation loss value to nodes, 500-2, . . . , 500-n, Because the global validation loss value is achieved using encrypted local validation loss values, the global validation loss value must be decrypted. Accordingly, the remaining nodes (not node 500-1, that was already elected a leader) may again engage in a decryptor election process. For example, node 500-2 may be elected to act as the decryptor, which can request the private key generated by the key manager, and then generate the global validation loss value by decrypting the encrypted version of the global validation loss value generated by node 500-1 to the decrypted version of the global validation loss value. In particular, node 500-2 may download the global validation loss value from node 500-1, and may decrypt the global validation loss value. Node 500-2 may upload the now-decrypted global validation loss value back to the node 500-1, and requests that the key manager discard the public/private key pair it generated permanently (which the key manager does). This ensures that no other nodes, including the leader, can request the private key to decrypt the local validation loss values of another node. The decryptor, node 500-2, signals the global validation loss value is ready and is available with the leader, node 500-1. The remaining nodes, other than node 500-2 (because it is already aware of the global validation loss value) may obtain the global validation loss value by downloading it from node 500-1, at which point, the training batch ends at 524. It should be understood that the global validation loss value may be used by each of the nodes, 500-1, 500-2 . . . , 500-n, to determine if further training iterations may be needed or if training can end.

It should be noted that in some embodiments, the validation loss values determined at each node 500-1, 500-2 . . . , 500-3 need not necessarily be encrypted prior to sharing, That is, the desire to maintain the privacy local data private may not necessarily carry over to keeping ML model performance information (validation loss value) private. Accordingly, as illustrated in FIG. 5B, the use of the key manager, and obtaining a public/private key, etc. may be skipped in some embodiments, and local validation loss values may simply be shared as-is, directly with the leader node 500-1. Likewise, decrypting the global validation loss value may also be skipped.

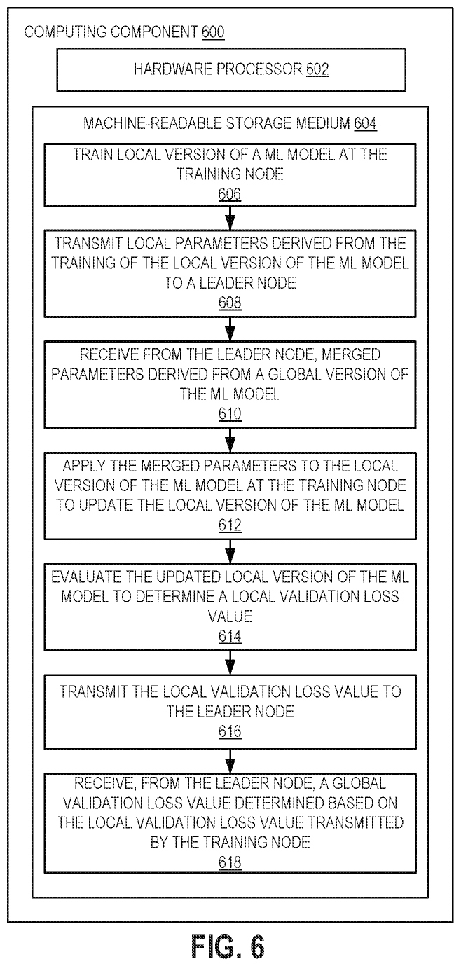

FIG. 6 is an example computing component 600 that may be used to implement various features of an elected merge leader in accordance with one embodiment of the disclosed technology. Computing component 600 may be, for example, a server computer, a controller, or any other similar computing component capable of processing data. In the example implementation of FIG. 6, the computing component 600 includes a hardware processor 602, and machine-readable storage medium 604. In some embodiments, computing component 600 may be an embodiment of processor 50 of edge node 10 (FIG. 1C).

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-618, to control processes or operations for merging local parameters to effectuate swarm learning in a blockchain context using homomorphic encryption. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-618.

Hardware processor 602 may execute instruction 606 to train a local version of a ML model at the training node. As described above, in distributed or decentralized ML networks, training of a ML model at, e.g., an edge node, may entail training a instance or version of a common, global model using training data at the edge node. The training data may be a training data subset of local data at the edge node. The local data may be partitioned into the training data subset and a validation data subset (used during validation of the model).

Hardware processor 602 may execute instruction 608 to transmit local parameters derived from training the local version of the ML model to a leader node. As described above, data privacy may be presented in accordance with some embodiments by using homomorphic encryption, where one of the nodes may be elected to be a leader. As a leader node, the node may merge the local parameters from each of the nodes derived from training the local version of the ML model at each of the nodes. The leader may request a separate key manager to generate an asymmetric key pair used for the homomorphic encryption.

Accordingly, hardware processor 602 may execute instruction 610 to receive, from the leader node, merged parameters derived from a global version of the ML model. Due to the homomorphic encryption used to encrypt the localized parameters derived from the local versions of the global version of the ML model, a decryptor node may be selected (that is not the leader node) to decrypt the encrypted version of the merged parameters (from the leader node). The decrypted version of the merged parameters may be obtained by the edge nodes.

Hardware processor 602 may execute instruction 612 to apply the merged parameters to the local version of the ML model at the training node to update the local version of the ML model. This occurs at each edge node of the network.

Upon completing a local training iteration/epoch, each node may then validate its ML model. Accordingly, hardware processor 602 may execute instruction 614 to evaluate the updated local version of the ML model to determine a local validation loss value, That local validation loss value (like the parameters derived from the training of the local ML models at each of the nodes) may be sent the elected leader node. Upon receiving the local validation loss values from the other nodes in the network, the elected leader node may average the local validation loss values to arrive at a global validation loss value that may be returned to each of the nodes.

Hardware processor 602 may execute instruction 616 to transmit the local validation loss value to the leader node. As described above, the leader node may request another asymmetric key pair to be generated so that the local validation loss values may be encrypted by each of the nodes prior to transmission to the leader node. The leader node, upon receipt of the local validation loss values from the nodes of the distributed network, may average these local validation loss values to arrive at a global validation loss value.

Accordingly, hardware processor 602 may execute instruction 618 to receive, from the leader node, a global validation loss value determined based on the local validation loss value transmitted by the training node. As noted above, validation loss values may be used to determine if training of a model can cease or if further training is required to meet a desired level of performance. Here, the global validation loss value may be used by each node to determine if it should continue training its local version of the common global model or if training can cease.

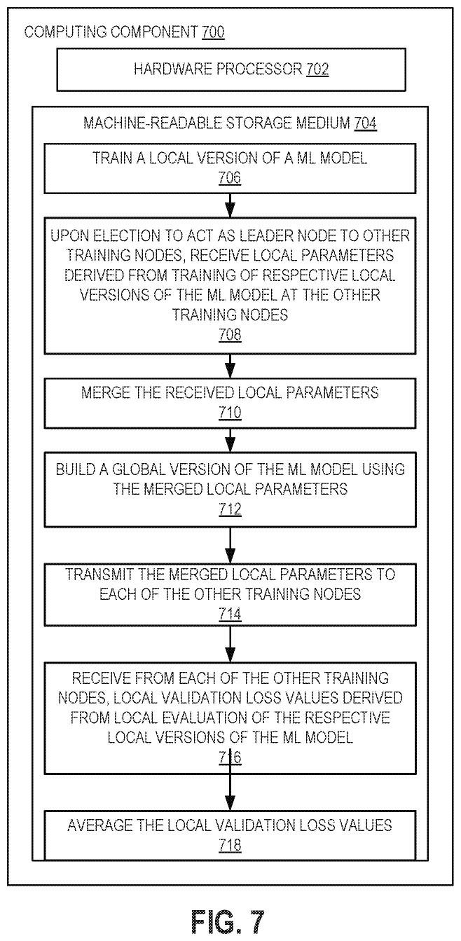

FIG. 7 is an example computing component 700 that may be used to implement various features of an elected leader node in accordance with one embodiment of the disclosed technology. Computing component 700 may be, for example, a server computer, a controller, or any other similar computing component capable of processing data. In the example implementation of FIG. 7, the computing component 700 includes a hardware processor 702, and machine-readable storage medium 704. In some embodiments, computing component 600 may be an embodiment of processor 50 of edge node 10 (FIG. 1C).

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-718, to control processes or operations for merging local parameters to effectuate swarm learning in a blockchain context using homomorphic encryption. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), nonvolatile RAM (NVRAM), an Electrically Erasable Programmable Read-Only Memory (EEPROM), a storage device, an optical disc, and the like. In some embodiments, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-718.

Hardware processor 702 may execute instruction 706 to train a local version of a ML model. Again, as described above, distributed or decentralized machine learning involves training local versions of a ML model at multiple nodes using local data at those nodes. That local data can, prior to training be partitioned into training and validation datasets. The training dataset may be used for training the local versions of the ML model, while the validation dataset may be used to determine how well/poor that local version of the ML model is performing.

Hardware processor 702 may execute instruction 708 to, upon election to act as leader node to other training nodes, receive local parameters derived from training of respective local versions of the ML model at the other training nodes. As described above, precautions may be taken to preserve the privacy of the local data. As part of those precautions, a leader node is elected to perform localized ML model parameter merging. That leader node may request generation of a public key (of a public/private key pair used for asymmetric encryption) from a key manager to be used by each of the training nodes to encrypt their local parameters.

Hardware processor 702 may execute instruction 710 to merge the received local parameters. Upon receiving the local parameters from each of the training nodes (including itself), the leader node may merge the local parameters. In this way, hardware processor 702 may execute instruction 712 to build a global version of the ML model using the merged local parameters.

Hardware processor 702 may execute instruction 714 to transmit the merged local parameters to each of the other training nodes. The merged local parameters may be transmitted by the leader node upon receiving a decrypted version from another node elected to act as a decryptor. By separating merge/encryption and decryption operations between different nodes, data privacy can be maintained as the public/private key pair (together) is not known by any single node.

As noted above, the local data at each training node may be split into training and validation datasets. Upon completion of a training iteration, each node may perform a validation procedure to determine how its local ML model version is performing. The leader node, may, similar to merging of the local parameters, may average the local validation loss values from each of the training nodes (including itself. Accordingly, hardware processor 702 may execute instruction 716 to receive from each of the other training nodes, local validation loss values derived from local evaluation of the respective local versions of the ML model.

Hardware processor 702 may execute instruction 718 to average the local validation loss values to arrive at a global validation loss value that may be used by all the training nodes, Upon averaging the local validation loss values, the leader may distribute that global validation loss value to each of the other training nodes.

Various embodiments of the disclosed technology are able to distribute computations for performing cryptographic operations to all participants in a near-uniform fashion. That is, all nodes participate in ML model training, contribute parameters to merge, etc., although some nodes, such as the merge leader node which performs merge functions or the decryptor that decrypts data perform operations are not performed by every node. Moreover, various embodiments employ a swarm learning/parameter merging process or algorithm that can be distributed across all participants of a blockchain network such that implementation can be easily scaled. Further still, implementation of the various embodiments provides a fault tolerant solution to ML and model training, despite the distributed, swarm learning aspect, where many operations are independently performed by edge nodes.

It should be understood that although various embodiments described herein are presented in the context of a blockchain framework to preserve data integrity, from a validation standpoint, use of a blockchain ledger is not necessary. That is, local ML models of participating nodes can be validated in accordance with various embodiments regardless of how distributed learning regarding those local ML models is performed. For example, local ML model training at each participating node in an edge network, for example, may be performed using conventional distribution ML techniques. However, as described above, upon completion of a training iteration, validation loss can be calculated locally, shared with a leader node that can average the local validation loss values, and return to the participating nodes, a global validation loss value without a need for a blockchain ledger or other blockchain-related mechanisms. Rather, the nodes may communicate, e.g., local validation loss values directly to an elected leader, and vice versa.

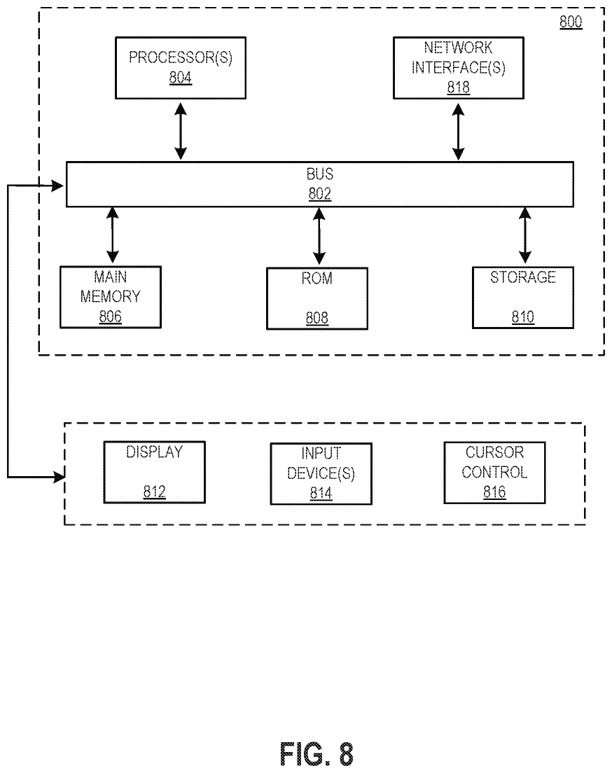

FIG. 8 depicts a block diagram of an example computer system 800 in which various embodiments described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some embodiments, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806, Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a communication interface 818 coupled to bus 802. Network interface 818 provides a two-way data communication coupling to one or more network links that are connected to one or more local networks. For example, coma communication interface 818 may be an integrated services digital network (ISDN) card, cable modem, satellite modem, or a modem to provide a data communication connection to a corresponding type of telephone line. As another example, network interface 818 may be a local area network (LAN) card to provide a data communication connection to a compatible LAN (or WAN component to communicate with a WAN). Wireless links may also be implemented. In any such implementation, network interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 818, which carry the digital data to and from computer system 800, are example forms of transmission media.

The computer system 800 can send messages and receive data, including program code, through the network(s), network link and communication interface 818, In the Internet example, a server might transmit a requested code for an application program through the Internet, the ISP, the local network and the communication interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used here, a circuit or component might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits or components described herein might be implemented as discrete circuits/components or the functions and features described can be shared in part or in total among one or more circuits/components. Even though various features or elements of functionality may be individually described or claimed as separate circuits/components, these features and functionality can be shared among one or more common circuits/components, and such description shall not require or imply that separate circuits/components are required to implement such features or functionality, Where a circuit/component is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting, Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A training node, comprising:
a processor; and
a memory unit operatively connected to the processor, the memory unit including instructions that when executed, cause the processor to:
train a local version of a machine learning (ML) model at the training node;
transmit local parameters derived from the training of the local version of the ML model to a leader node;
receive from the leader node, merged parameters derived from a global version of the ML model;
apply the merged parameters to the local version of the ML model at the training node to update the local version of the ML model;
evaluate the updated local version of the ML model to determine a local validation loss value;
transmit the local validation loss value to the leader node;
receive from the leader node, a global validation loss value determined based on the local validation loss value transmitted by the training node.

2. The training node of claim 1, the instructions that when executed cause the processor to train the local version of the ML model further cause the processor to train the local version of the ML model using a training data subset of a local dataset at the training node.

3. The training node of claim 2, wherein the instructions that when executed cause the processor to evaluate the local version of the ML model further cause the processor to evaluate the local version of the ML model using a validation data subset of the local dataset at the training node.

4. The training node of claim 3, wherein the local dataset is divided into the training data and the validation data subsets prior to a local training iteration.

5. The training node of claim 1, wherein the instructions that when executed cause the processor to train the local version of the ML model further cause the processor to train the local version of the ML model in batches.

6. The training node of claim 1, wherein the memory unit includes instructions that when executed further cause the processor to transmit the local validation loss value to the leader node.

7. The training node of claim 1, wherein the memory unit includes instructions that when executed further cause the processor to receive an averaged validation loss value from the leader node.

8. The training node of claim 1, wherein the memory unit includes instructions that when executed further cause the processor to homomorphically encrypt the local validation loss value using a public key of a public and private key pair.

9. The training node of claim 1, wherein the memory unit includes instructions that when executed further cause the processor to one of continue the training of the local version of the ML model or end the training of the local version of the ML model based on the global validation loss value.

10. The training node of claim 1, wherein the training node, the leader node, and additional nodes operate in a distributed swarm learning blockchain network.

11. A training node, comprising:
a processor; and
a memory unit operatively connected to the processor, the memory unit including instructions that when executed, causes the processor to:
train a local version of a machine learning (ML) model;
upon election to act as a leader node to other training nodes, receive local parameters derived from training of respective local versions of the ML model at the other training nodes;
merge the received local parameters;
build a global version of the ML model using the merged local parameters;
transmit the merged local parameters to each of the other training nodes; and
receive from each of the other training nodes, local validation loss values derived from local evaluation of the respective local versions of the ML model; and
average the local validation loss values.

12. The training node of claim 11, wherein the instructions that when executed cause the processor to the build the global version of the ML model further causes the processor to build the global version of the ML model based on a local parameter derived from the training of the local version of the ML model at the training node in addition to the local parameters derived from the training of the respective local versions of the ML model at the other training nodes.

13. The training node of claim 11, wherein the instructions that when executed cause the processor to train the local version of the ML model comprise instructions that when executed further cause the processor to train the local version of the ML model using a training data subset of data local to the training node.

14. The training node of claim 13, wherein the memory unit includes instructions that when executed further cause the processor to calculate a local validation loss value using a validation data subset of the data local to the training node.

15. The training node of claim 14, wherein the instructions that when executed cause the processor to average the local validation loss values comprises instructions that when executed cause the processor to average the local validation loss values from each of the other training nodes in addition to the local validation loss value calculated by the training node

16. The training node of claim 11, wherein the training node and the other training nodes comprise a distributed ML network.

17. The training node of claim 16, wherein the instructions that when executed cause the processor to receive local parameters, build the global version of the ML model, transmit the merged local parameters, and receive the local validation loss values, further causes the processor to receive local parameters, build the global version of the ML model, transmit the merged local parameters, and receive the local validation loss values using a distributed blockchain ledger.

18. The training node of claim 11, wherein the memory unit includes instructions that when executed further causes the processor to request a key manager to generate an asymmetric key pair with which the local parameters are encrypted and with which the merged local parameters are decrypted.

19. The training node of claim 18, wherein the memory unit includes instructions that when executed further causes the processor to request a key manager to generate another asymmetric key pair with which the local validation loss values are encrypted and with which the averaged local validation loss values are decrypted.

20. The training node of claim 11, wherein the memory unit includes instructions that when executed further cause the processor to transmit the averaged local validation loss values to the other training nodes as a training performance indicator of the respective local versions of the ML model at the other training nodes.
